(19) United States
(12) Patent Application Publication
(10) Pub. No.: US 2002/0035460 A1
(43) Pub. Date: Mar. 21, 2002

(54) System and method for network infrastructure management

(76) Inventor: Robert J. Hales, Tampa, FL (US)

Correspondence Address: DICKSTEIN SHAPIRO MORIN & OSHINSKY LLP, 2101 L STREET NW, WASHINGTON, DC, 20037-1526, US

(21) Appl. No.: 09/897,429

(22) Filed: Jul. 3, 2001

Related U.S. Application Data
(60) Provisional application No. 60/234,303, filed on Sep. 21, 2000.
(60) Provisional application No. 60/236,040, filed on Sep. 28, 2000.

(51) Int. Cl. G06F 17/50

(52) U.S. Cl. 703/13

(57) ABSTRACT

A system, method is provided for engineering, deploying, and/or maintaining a network such as a communications network. A computer, and application software, support a method of recording the characteristics of network components and their geographic locations relative to a map. Graphical and tabular display of the stored information, along with automatic functions for calculating system attributes such as power supply load and signal strength throughout the network are included. Networks including various transmission media, such as coaxial cable, optical fiber, and wireless are supported. Automatic wireless signal strength data collection, and fiber by fiber optical cable tracking are among further features of the invention.

### CROSS REFERENCE TO RELATED APPLICATIONS

Priority is claimed of U.S. Provisional Patent Applications No. 60/234,303, filed Sep. 21, 2000, and No. 60,236,040, filed Sep. 28, 2000, which Applications are incorporated herein in their entirety.

### FIELD OF THE INVENTION

The present invention relates to network management systems, and more particularly to network engineering, deployment, and maintenance systems.

### BACKGROUND OF THE INVENTION

Communication networks and electric power distribution grids are two important examples of complex, multicomponent, systems.

Communication networks include transmission media such as coaxial cable and fiber-optic cable, active components such as electronic or optical amplifiers, power supplies, interface devices, and a wide variety of structural components such as junction boxes, poles, conduits, and pedestals. Such networks generally involve many components, and form complex systems. In order for such systems to be successfully designed, implemented, and maintained, this complexity must be mastered. The characteristics and locations of particular components, and the physical and functional relationships between components, must be identified, recorded, and made accessible for future reference.

Planning for the installation of such systems, including locating components, and engineering the functional relationships between them, requires the management of large volumes of information. The deployment, and on-going maintenance of such systems requires the handling and coordination of similarly large amounts of information.

As with most engineering functions, this management of information has historically been performed manually using paper drawings and other documentation. The process has been labor-intensive, and prone to error due to problems in communication, mistakes in representation of components, miscalculation of relationships, and the delays intrinsic to managing large amounts of information with finite resources. Computerized systems, while offering advantages over manual systems, have not provided the desired functionality.

### SUMMARY OF THE INVENTION

The present invention capitalizes on the information management efficiency offered by computers to provide a system for planning and recording the locations and relationships of communication network components while overcoming many of the disadvantages of prior art approaches.

According to one aspect of the invention, a general-purpose computer and specialized application software are employed. The application software includes a catalog portion, including a database of the defining characteristics of components appropriate to the type of network (for example a communications network) being designed. The application software also includes a design profile portion which identifies a ready selection of interoperable components to be used in a particular design. Also included is a project storage portion of the software which records the characteristics of a particular network as it is being designed, including the characteristics and interrelationships of its components. A user interface portion is adapted to present the design as it exists at any particular point in time for examination by the designer or other parties. This presentation is made in graphical or tabular form, according to the needs of the reviewer.

In further aspects, the invention supports the engineering of a network, including analysis of signal power relationships, and of the structural performance of various mechanical components.

In yet further aspects, the application software provides output capabilities including plotting of working diagrams, and communications with remote terminals. These capabilities are of particular value in the deployment and ongoing maintenance of the network.

In one embodiment, software is employed that allows a system designer to develop a graphical representation of the particular network, or portion of network, as it is being designed. The graphical representation is presented on a computer screen and is readily changed during the course of the design. The process of designing a network begins with the development of the geographic map or landbase onto which a representation of the network's physical components are overlaid. A user selects mapping conventions that allow the system to relate the data that input into a project.

The software reads the mapping scheme and from the mapping conventions determines how to store data and graphics within the global mapping system. This global mapping relational system gives a user the ability to work seamlessly in a particular geographic area, and to add or remove additional mapping area sessions as needed. This electronic representation of the geographic map relates all of the map objects, devices, and land structures to each other, and the entire map system to the project as a whole.

Mapping conventions include map grid settings and map naming. In one embodiment of the invention several grid conventions are available, such as are known to those of skill in the art. These include the Cadastre mapping system, the equal area grid system, the atlas system, the state plane coordinate system, and the UTM system.

Once mapping conventions have been established, roads, buildings, and other landbase features are added to the network model. In one embodiment roads of various types and descriptions are included, and the styling options related to the representation of the road on the map are defined. Other features that are added to maps include boundary lines.

Having established the basic characteristics of the underlying geographic map, and mapped landbase features, a designer begins selecting and locating the various physical components of the communications network. For example, poles or pedestals are located. Similarly the designer locates conduit and cabinets, connector types, reels, amplifiers, lasers, splitters, combiners, and emulators, patch panels, and optical switches. Each component selected is identified and characterized within the project database of the system.

Accordingly, the present invention includes a system and method for engineering, deploying, and maintaining the infrastructure of a network such as communications network. The system includes a computer and application software. In some embodiments, the system includes several or many computers configured as part of a network for mutual communication. The application software includes software to perform functions adapted to support the method of the invention as hereafter described.

The present invention also relates to a method that includes steps that define and store the locations of network components, the functional characteristics of those components, and their logical and functional interrelationships. The method also includes using this stored information to perform calculations that characterize a network, and guide efforts to engineer and organize it.

The method further includes using stored information to display graphical images and generate reports useful in engineering, deploying, and maintaining a network. The method includes supporting communications between personnel as they engineer, deploy, and maintain the network. In sum, the system and method constitute a multifunctional integrated computerized tool adapted to support network infrastructure management.

These and other features, and advantages, of the present invention will become apparent to those of skill in the art from the following drawings and description which illustrate various aspects of the invention.

### BRIEF DESCRIPTION OF THE DRAWINGS

FIG. 1 illustrates the system of the invention in block diagram form, including a general-purpose computer and application software;

FIG. 2 illustrates, an aspect of the invention in which application software with limited functionality is provided to a remote portable computer that communicates with a server computer;

FIG. 3 illustrates an aspect of the invention in which information communicated from a computer terminal is used to operate application software of the invention on a server remote from the terminal;

FIG. 4 illustrates principal functional aspects of the application software of the invention, in block diagram form;

FIG. 5A illustrates a catalog database of the present invention, in block diagram form, including various exemplary network components;

FIG. 5B illustrates functions associated with a Master Fiber Catalog;

FIG. 6 illustrates, in block diagram form, sub-functions of a recalc design function adapted to identify improperly configured aspects of a network under design according to the invention;

FIG. 7 illustrates, in block diagram form, sub-functions of a function adapted to calculate power levels for a power supply inserted in a network during network design according to the invention;

FIG. 8A illustrates, in flow diagram form, steps for designing a network according to the present invention;

FIG. 8B illustrates, in flow diagram form, steps for deploying a network, according to the present invention;

FIG. 8C illustrates, in flow diagram form, steps for maintaining a network according to the present invention;

FIG. 9 illustrates various substeps of the step of defining a design profile, in flow diagram form;

FIG. 10 illustrates, in flow diagram form, various substeps performed as a user begins an active design according to the method of the invention;

FIG. 11 illustrates steps involved in communication between a server and a remote portable computer in flow diagram form;

FIG. 12A shows, in schematic form, a portion of a network adapted to wireless communication;

FIG. 12B shows, in block diagram form, a mobile apparatus for measuring the signal strength of a wireless communication signal, and relating that signal strength to geographic location;

FIG. 13 illustrates exemplary graphical and tabular fiber link reports, according to one embodiment of the present invention;

FIG. 14 illustrates exemplary graphical and tabular splice reports, according to one embodiment of the present invention;

FIG. 15A illustrates an aspect of the software of the invention whereby optical cable incorporating a plurality of fiber grades within a single buffer tube is modeled effectively;

FIG. 15B illustrates a method of calculating optical loss according to one aspect of the invention;

FIG. 16 illustrates the storage of fine-scale information by means of a detail note functionality; and

FIG. 17 illustrates a function of the invention whereby floor plans and risers of a multiple dwelling unit are modeled at high-resolution.

### DETAILED DESCRIPTION OF THE INVENTION

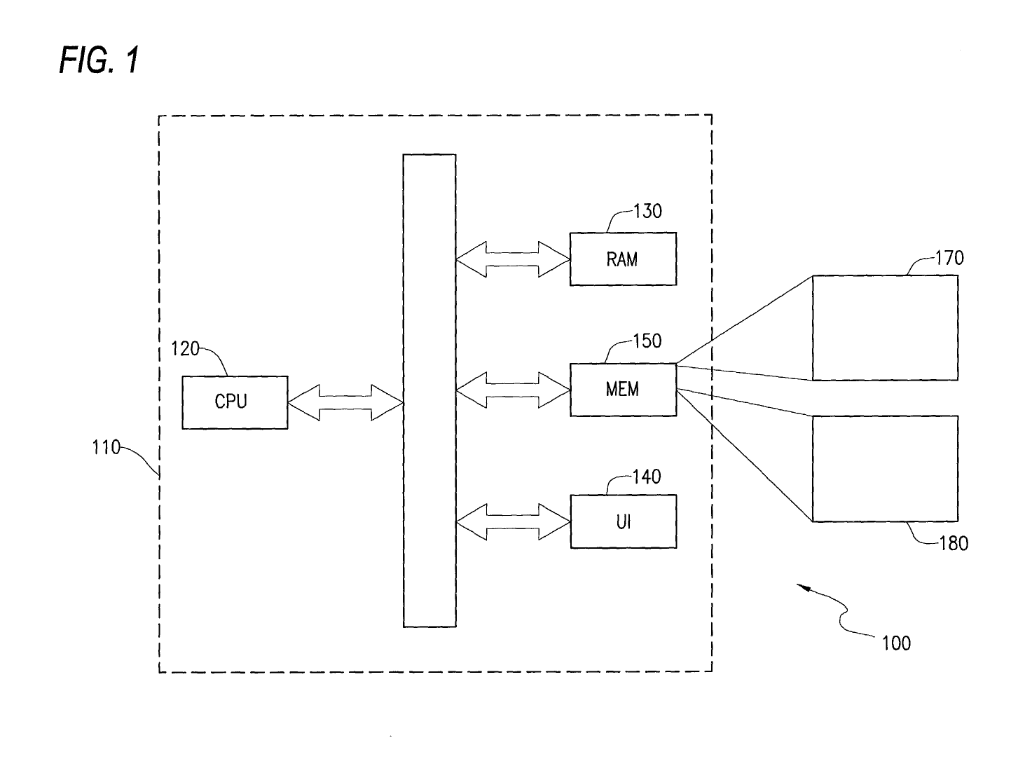

Referring to FIG. 1 the invention includes an integrated system 100 for engineering, deploying, and maintaining, a communications network. In one aspect the integrated system includes a general-purpose computer 110 including a central processing unit (CPU) 120, random access memory (RAM) 130, a user interface device (UI) 140, and a further memory storage unit (MEM) 150 containing stored application program software 170, and adapted to contain application data 180.

Execution of the application program 170 by a user, using the general-purpose computer 110, allows the user to store and manipulate data related to the engineering, deployment, and maintenance, of the various components of a network, and in particular of a communications network.

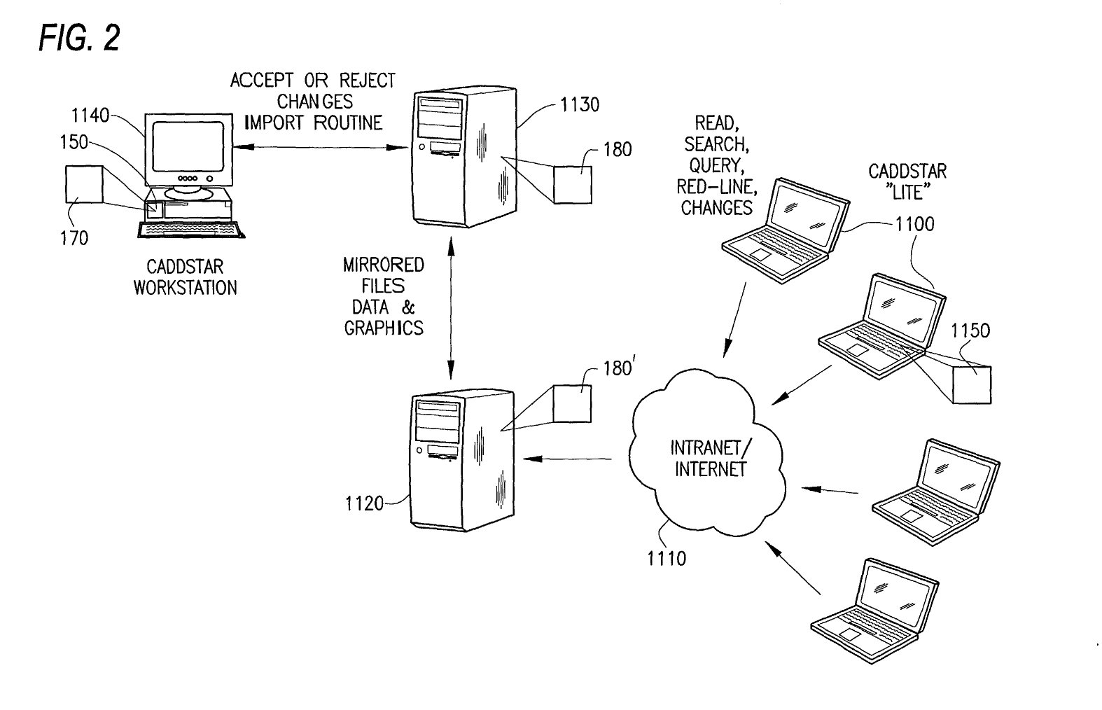

Referring to FIG. 2, in a further aspect, the invention includes a workstation 1140 corresponding to the general-purpose computer 110 of FIG. 1. The workstation contains a memory unit 150 within which is stored an application software program 170. The workstation is operatively connected to a first server computer 1130 adapted to contain application data 180. The first server computer 1130 is operatively connected for communication with a second server computer 1120 on which application data 180 is mirrored 180′. Accordingly, first 1130 and second 1120 servers each contain a set of application data 180, 180′. The two sets of mirrored application data are identical on a substantially instantaneous basis. The second server 1120 is operatively connected via a communication network 1110, such as the Internet, for communication with at least one portable computer 1100 positioned at a location remote from the second server 1120. According to the invention, the portable computer 1100 contains an application program 1150 having functionality including a subset of the functionality of the application software program 170 stored in the workstation 1140.

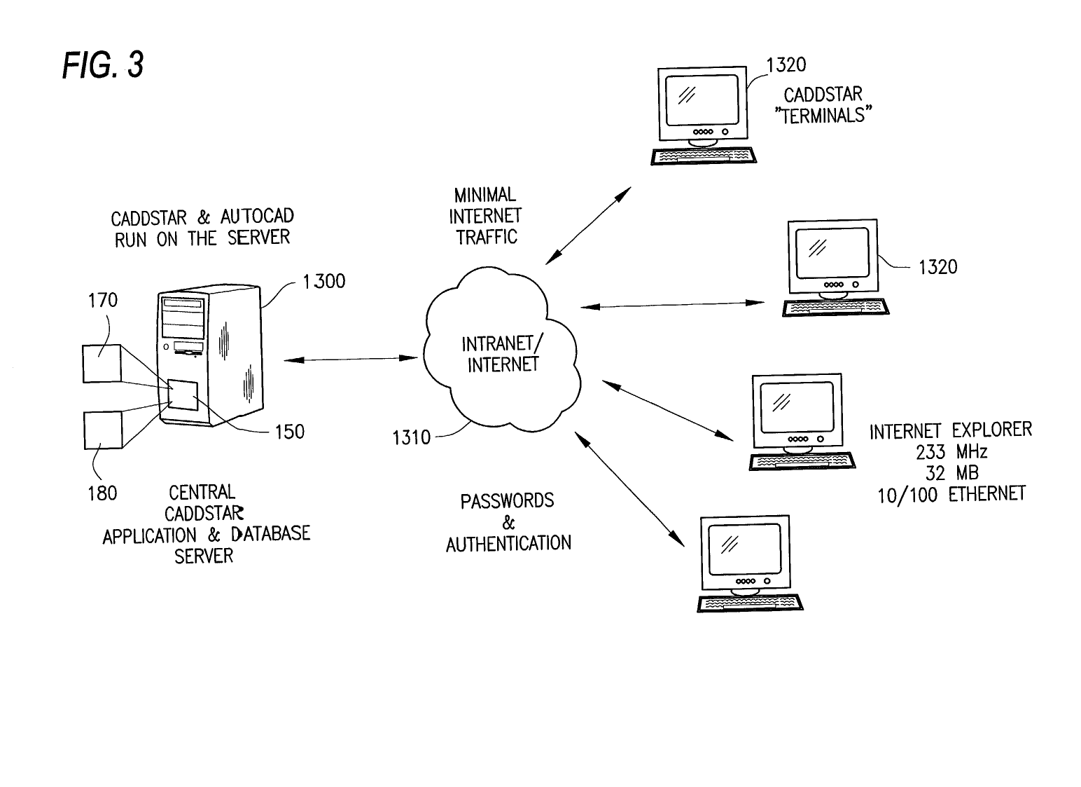

Referring to FIG. 3, in another aspect, the invention includes a server 1300 corresponding to the general-purpose computer 110 of FIG. 1. The server 1300 contains a memory unit 150 within which is stored an application software program 170. Also stored within the memory unit 150 of the server 1300 is a set of application data 180. The server 1300 is operatively connected via a communications network 1310, such as the Internet, with at least one computer terminal 1320 positioned at a location remote from the server 1300. In one aspect of the invention, the computer terminal 1320 is a computer running a terminal emulation program.

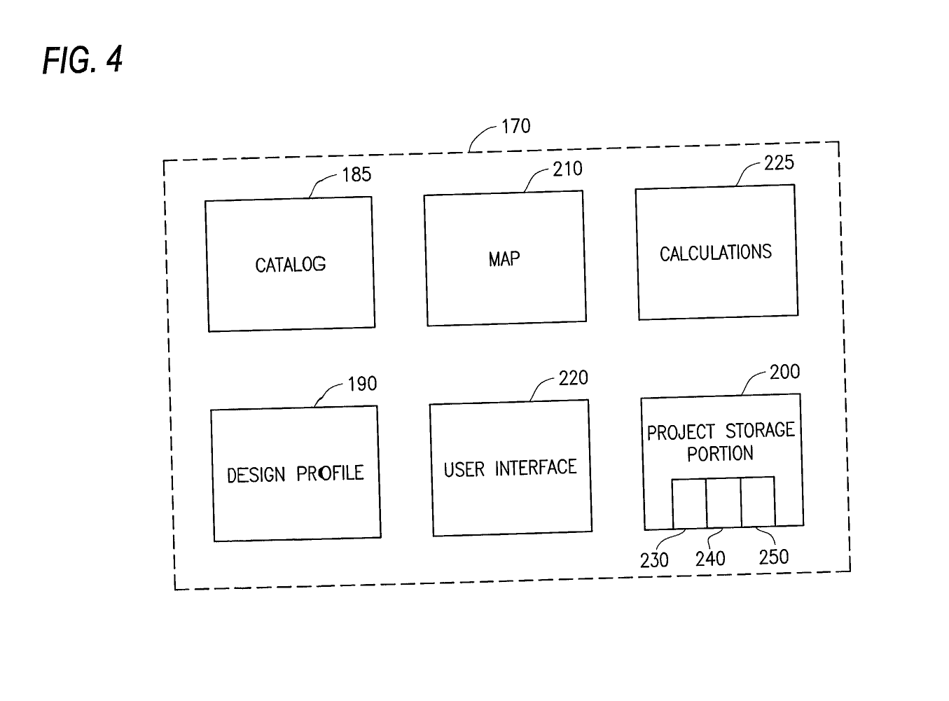

FIG. 4 shows in further detail some of the functional components of the application software 170, according to one embodiment of the invention. In certain aspects the software includes a catalog of components 185. The catalog includes a plurality of data sets, each data set defining the characteristics of a communications system component. The program also includes a design profile portion 190. The design profile portion identifies catalog components and project specific design rules associated with a particular design project. Another portion of the program is a project storage portion 200 that records the characteristics of a particular communication network as it is being designed. In one embodiment the project storage portion includes three separate but related databases, an active components database 230, a passive components database 240, and a bearing components database 250, containing information for a particular project related to the active components such as amplifiers, passive components such as cables, and bearing components such as utility poles, respectively. The application software 170 also includes a functional portion that performs calculations 225 including calculations for selecting components, and calculations for confirming that selected components will function together.

A map or landbase portion 210 stores the geographic and hydrographic features of a region in which the components of the network are to be installed. A User Interface Portion 220 provides functionality that displays project data in graphical and tabular form, and that permits in the input by a user of additional data.

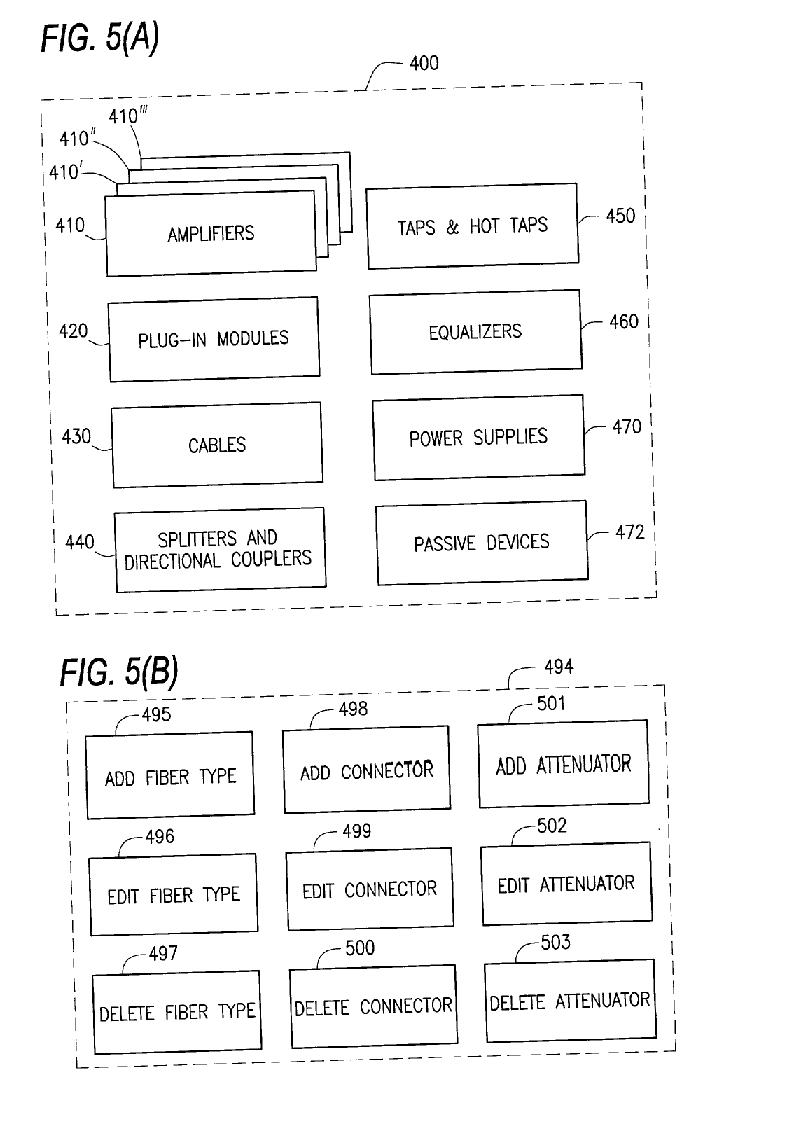

Referring to FIG. 5A, one sees that an exemplary catalog database 400 includes a plurality of records. Each record incorporates information characterizing a particular hardware component such as might be employed in a network.

Exemplary components found in a cable component catalog include amplifiers 410, plug-in modules 420, cables 430, splitters and directional couplers 440, taps and hot taps 450, equalizers 460, power supplies 470, and passive devices 472. It should be noted that the catalog 400 may contain, for example, many different types, configurations, or varieties of amplifiers 410. In a particular embodiment of the invention, one record is present in the catalog for each such type, configuration, or variety (410, 410′, 410″, 410″). The information stored in such a record provides a prototype upon which a logical representation of an instance of a particular amplifier within a particular network is based. To create such a logical instance of a particular amplifier, the information stored in a prototype record is copied into a project storage portion 200 (FIG. 5) of the application data. Additional information added to the application data further configures the instance of the amplifier, and makes it part of a logical model of a network.

In one embodiment of the invention several different catalogs are available. One catalog, for example, contains information related to optical network components, another contains information related to cable network components, and of third contains information related to wireless network components. Additional catalogs are available in various embodiments that contain custom configurations of components, including, for example, combinations of optical and wireless components.

As described above each catalog includes information related to various components used in the development of a network. Additionally, the program includes discrete setting files and design profile files. Design profile files include data that selects a subset of catalog and make it available in a particular design activity, and also data that defines the specifications to be applied in the particular design activity. For example, the design profile may define drop levels, signal levels, trunk levels, express feeder levels, and mini-trunk levels. Settings files define component parameters.

One of the catalogs available according to one embodiment of the invention, is a Master Fiber Catalog which is adapted contain information related to fiber optic based networks. The Master Fiber Catalog includes a library of customizable fiber design facilities and management systems. Using a master fiber catalog a user can set up and manage the various elements of a fiber optic system.

FIG. 5B illustrates functions associated with a Master Fiber Catalog 494 including “Add Fiber Type” 495, “Edit Fiber Type” 496, and “Delete Fiber Type” 497. Similarly, the Master Fiber Catalog offers “Add Connector” 498, “Edit Connector” 499, and “Delete Connector” 500, and “Add Attenuator” 501, “Edit Attenuator” 502 and “Delete Attenuator” 503. Each of these functions allows the user to change the contents of the Master Fiber Catalog to conform to the characteristics of available physical components.

According to an aspect of the invention, the Fiber catalog supports equipment types including EDFA optical amplifiers, and ADM repeaters, WDM/DWDM lasers, splitters, and combiners, optical attenuators, optical repeaters, optical transmitters, splice enclosures, splice trays, fiber cables, connectors, patch panels and optical switches.

In one embodiment, a fiber catalog includes user definable fiber optic cable construction type. Such construction types include loose-tube construction, central-tube construction, buffer construction, and ribbon cable.

An embodiment of the invention records optical fiber cable construction type and characteristics including 1-2592 fibers per reel, 136 buffers per reel, 1-72 fibers per buffer or bundle, fiber reel covering type, connector types individually for each reel end, and odd fiber/buffer counts for tapered fiber segment support.

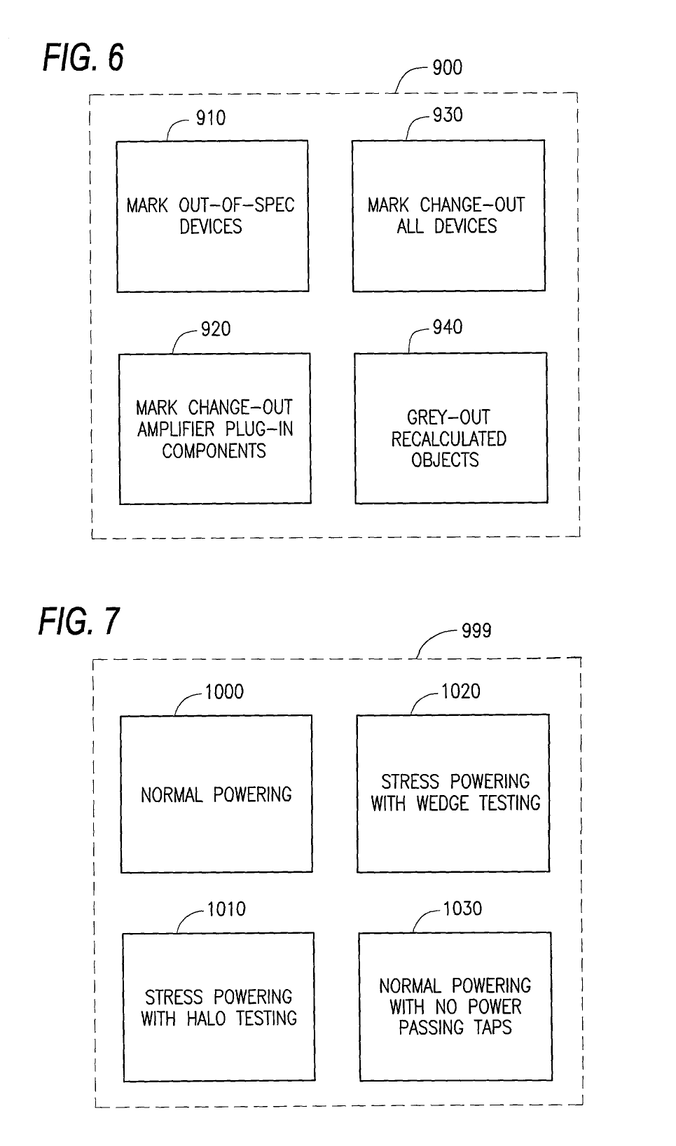

In a further aspect, the invention includes a function for calculating various limitations and characteristics of a network. For example, as indicated in FIG. 6, a recalculate design function 900 will display out-of-spec devices 910 with a graphical indication on the user interface 140. An example of an out-of-spec device is an amplifier having an excessively long run of coaxial cable connected to its output port.

Alternately, based on user selection, the recalculate design function 900 of the invention will mark, change-out amplifier plug-in components 920. Upon execution, this function calculates system parameters to discover any out-of-spec configuration of amplifier plug-in components. Where such and out-of-spec configuration exists, the system automatically modifies the design to replace out-of-spec taps and in-line equalizers that fall outside of the parameters of the design profile. According to one embodiment of the invention, amplifier plug-ins are not altered by this function.

Another aspect of the invention includes the mark, change-out all devices function 930, which after identifying an out-of-spec configuration, replaces all of the devices in the design that fall outside of the parameters of the design profile.

Yet another alternative is the grey-out recalculated objects function 940, which colors design paths gray as design calculations proceed.

FIG. 7 shows, a block diagram illustrating a function 999 for calculating power levels for a power supply inserted into a network during network design. Such calculations, as would be understood by one of skill in the art, include optional normal powering 1000 (calculated without stress testing); stress powering with halo testing 1010, which powers a random number of taps in the node; stress powering with wedge testing 1020, which double powers all taps downstream of an amplifier selected for wedge testing; and normal powering in a node with no power passing taps 1030.

In other aspects, the invention includes moving an amplifier location from one pole to another, changing the location of a device, using a predefined cable length, reconnecting devices previously placed, and specifying the attachment of a device to a pole fixture.

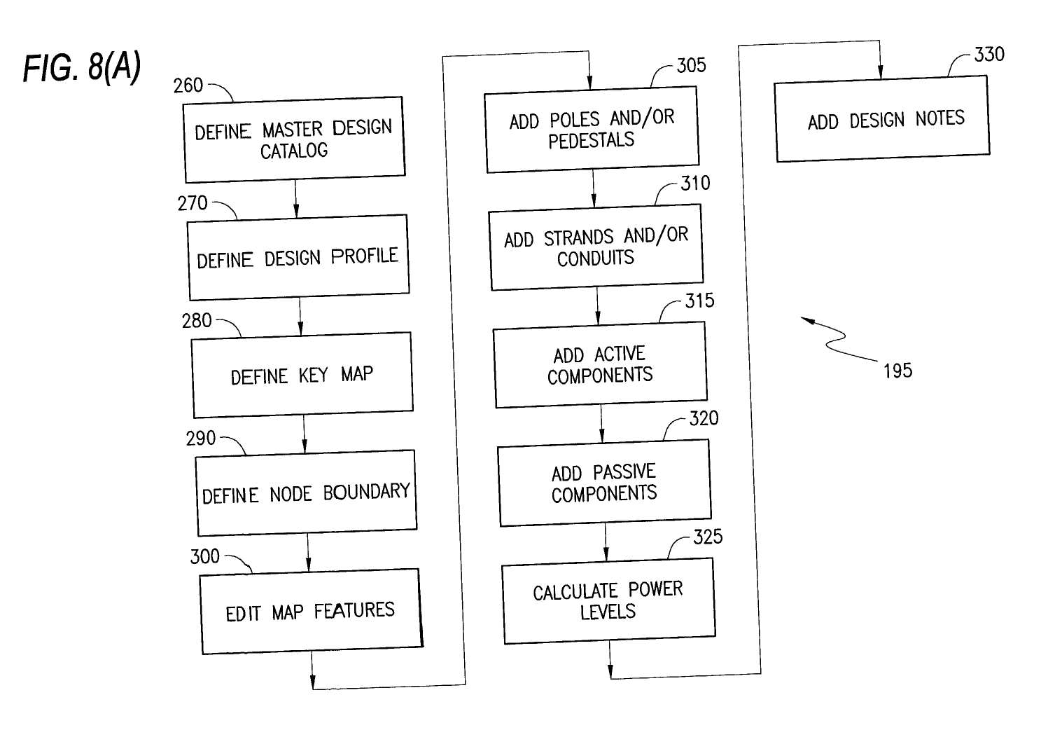

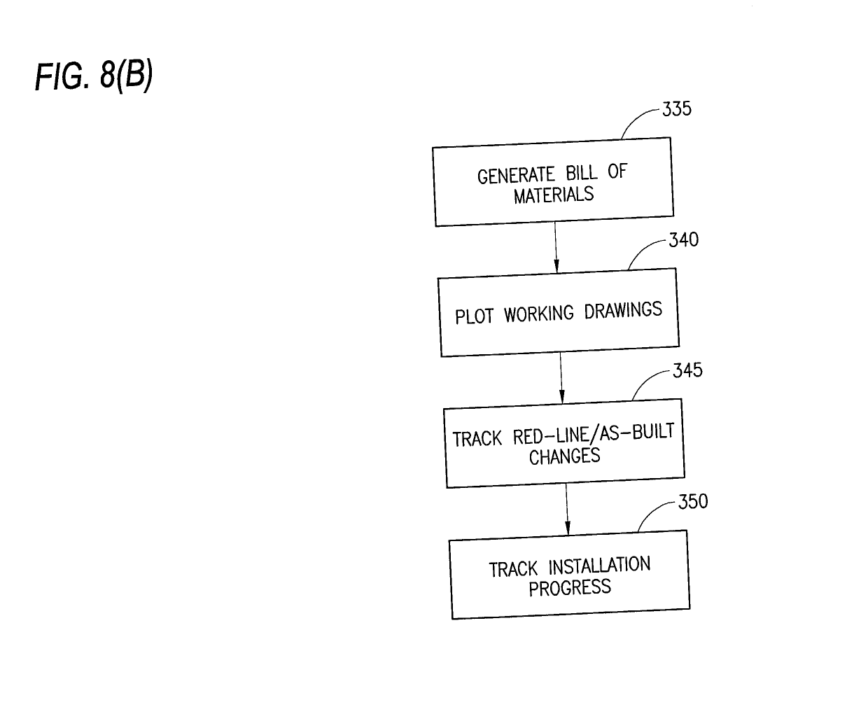

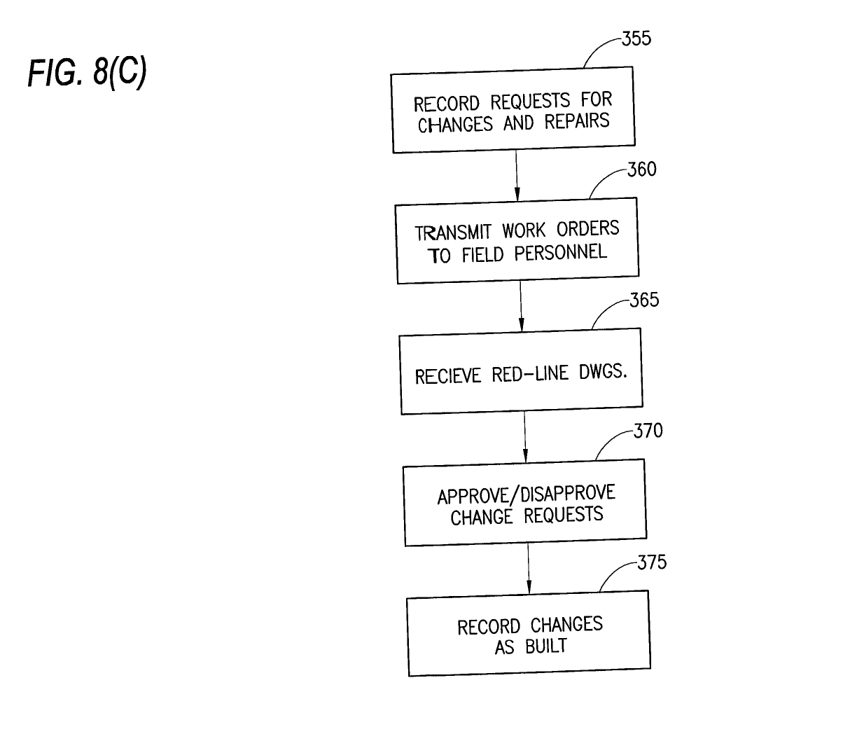

FIG. 8A illustrates a method 195 for engineering a communications network using the system and apparatus shown in FIG. 1. The engineering steps include defining a master design catalog 260, defining a design profile 270, defining a key map 280, defining a node boundary 290, editing map features 300 such as roads, boundary lines, and buildings, adding poles and/or pedestals 305, adding strands and/or conduits 310, adding active components 315, such as amplifiers, adding passive components 320 such as cables, attenuators, and splitters, calculating and recalculating power levels 325, and adding design notes 330.

As shown in FIG. 8B, deploying a communications network according to the invention includes the further steps of generating a bill of materials 335, plotting working drawings 340, recording as-built changes 345, and tracking system installation progress 350.

As shown in FIG. 8C, maintaining a communications network includes the further steps of recording requests for system changes and repairs 355, transmitting work orders to maintenance personnel 360, receiving red-line change requests from maintenance personnel 365, approving or disallowing red-line requests 370, and noting completion of maintenance activities and resulting system status 375.

The system, method, and apparatus of the present invention are suited to application in a wide variety of different communication systems, such as coaxial cable systems, optical fiber systems, wireless systems, and hybrid systems. Accordingly, the step of defining a master design catalog 200, indicated above, may include defining a database library of components appropriate to a plurality of technologies. In one embodiment of the invention, separate master design catalogs are provided for coaxial, fiber, and wireless systems.

For example, where the system to be designed includes coaxial cable, the step of defining 260 (FIG. 8A) a master design catalog 400 (FIG. 5) includes defining a database library including amplifiers 410; plug-in modules 420 such as forward pads and equalizers, and internal splitters; cables 430; external splitters and directional couplers 440; taps and hot taps 450; equalizers 460; power supplies 470; and various passive devices 472, as discussed above.

As discussed above, a design profile constitutes an inventory list identifying which items from the master design catalog are to be used (considered standard) for a particular design project.

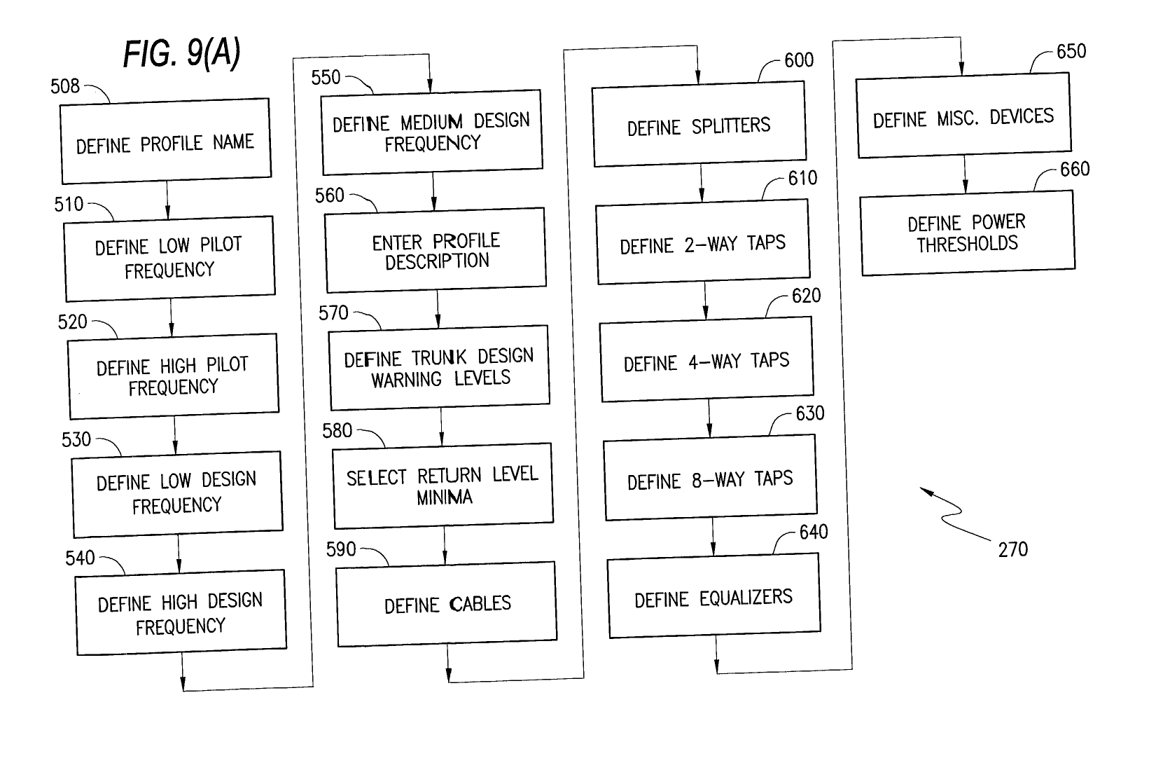

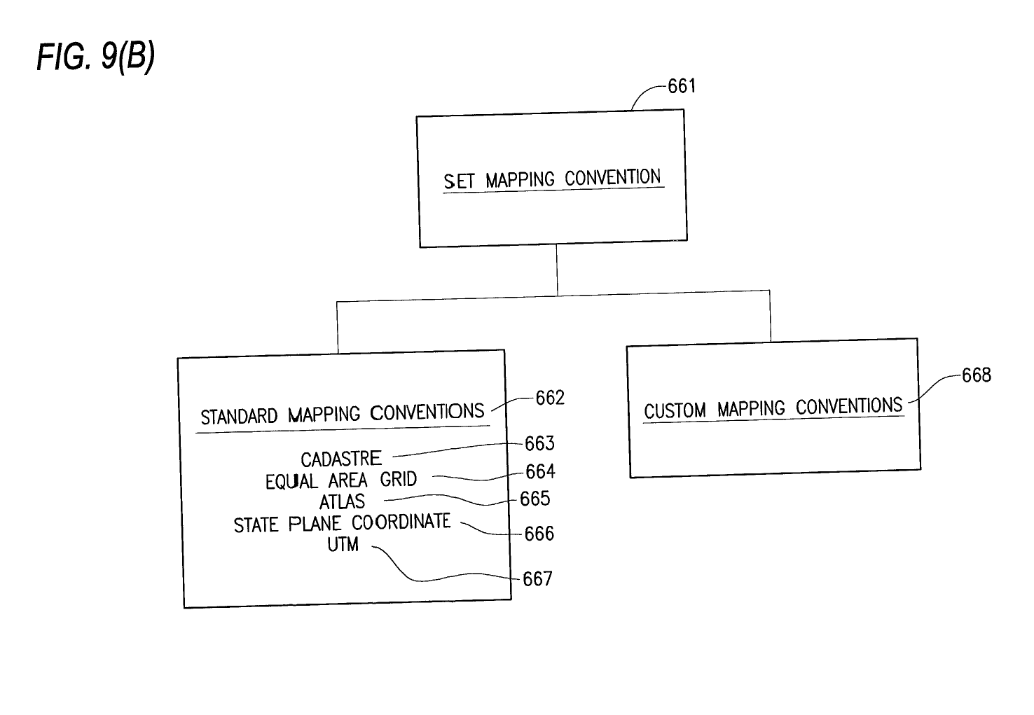

FIG. 9A shows, in further detail, the step of defining an exemplary cable network design profile 270 including defining the profile name 508, defining low 510 and high 520 pilot frequencies, as well as low 530, high 540, and medium 550 design frequencies. The pilot frequencies are nominal frequencies for system operation, but do not impose limits on the design calculations of invention. The design frequencies selected, in contrast, are used in calculating the choice and configuration of equipment. Violation of a design frequency threshold is reported to the user as a design error, and, in one embodiment of the invention, an offending network component will not be entered into the design.

Also included in defining a design profile 270 are the steps of entering a profile description 560 to document the profile under development, and defining trunk design warning levels 570 that are used to alert a designer that the signal level on a particular communications trunk are calculated to have reached a design threshold. A further step in defining a design profile is selecting standard return level minima 580. The standard return level minima specify the maximum signal that a return device will supply back to a tap. If, for example, a converter box or cable modem were able to send enough signal so that there was always 45 decibels available at the port for return, then the standard return level minimum would be set to 45 decibels. In one embodiment a detailed return calculation step provides a calculated value of the return signal level for a particular circuit.

Additional steps in defining a design profile 270 include defining the cables from the master design catalog available for use in the project 590, defining available splitters 600, defining available 2-way 610, 4-way 620, and 8-way 630 taps. Also included are the steps of defining the available equalizers 640, defining miscellaneous available devices 650, and defining power thresholds 660 for a particular project.

Referring now to FIG. 9B, during initial setup of the system, a mapping convention is established 661. The convention is typically selected from a number of standard mapping systems 662 such as the Cadastre system 663, the Equal Area Grid System 664, the Atlas system 665, the State Plane Coordinate System 666 and the the UTM system 667. In a further aspect of the invention, custom mapping conventions may also be defined 668.

Map naming, grid convention setup, measurement system setup, incrementing, and definition of origin also take place during initial setup.

Mapping conventions further define whether the mapping system will be measured in metric or English units, how the grid of the map will be denominated (whether with numbers or other characters), and the size and direction of increments between grid elements. Other aspects of mapping conventions definition include establishing mapping origin and map facet size. Accordingly, the foregoing map convention setup functions are incorporated into the application software 170 of the present invention. A key map defines the extent of the project area; i.e. the geographic area that the communication network, or network portion, and a particular project is to span.

In an embodiment of the invention, the steps of defining a key map 280 (FIG. 8A), and defining a node boundary 290, are performed using an input device. For example, a device such as a digitization pad is used to draw a polyline around a map region to define a key map.

Similarly a node is defined by drawing a Node Boundary Line 290 that encompasses an active node of the communications network and encloses an area to be serviced by that node.

One of skill in the art will understand that various steps indicated on FIG. 8A are performed repeatedly, so as to develop a logical representation of a communication network being engineered. This logical representation is stored in the project database, and in one aspect of the invention, is represented graphically. The steps involved typically include defining any roadways and other geographic or hydrographic features not already present on the key map; and locating individual houses, multiple dwelling units (MDU's), and other buildings within the key map region. Also repeated are the steps of locating utility poles of various types, trenches, conduits, risers, and junction boxes, and ultimately communications components such as transmitters, amplifiers, cable, etc.

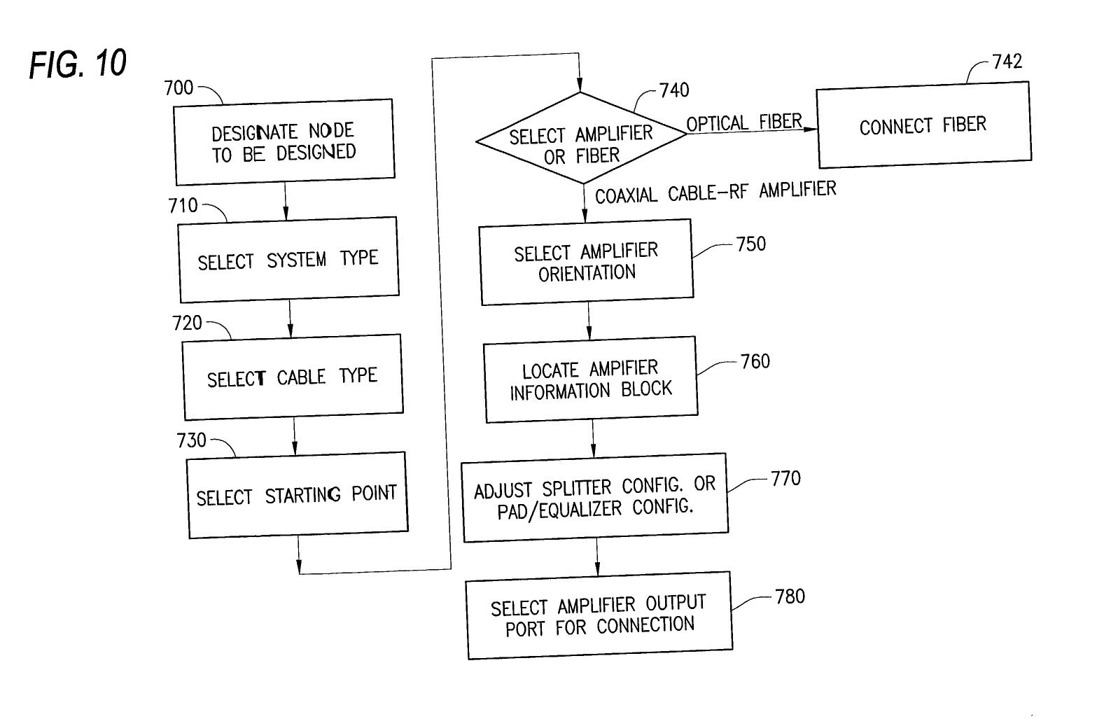

FIG. 10 illustrates, in flowchart form, the steps involved in beginning active design according to one aspect of the invention. These include designating a node to be designed 700; selecting a network type 710, for example optical fiber, trunk, express, or feeder; selecting a type of cable to be used 720, such as aerial or underground cable; selecting a starting point 730 at a point of connection to an existing design or at an arbitrary location; selecting an amplifier or optical fiber 740, depending on the transmission medium, for connection at the starting point. If optical transmission medium is selected, fiber connection is made 742. If an amplifier is selected, the process includes selecting an orientation for that amplifier 750; and locating an insertion point for an amplifier information block 760. If the amplifier includes a splitter or pad/equalizer, the process includes adjusting splitter configuration or pad/equalizer configuration 770. Finally, the amplifier insertion process includes selecting an available output port of the amplifier 780 for connection to a cable.

In one aspect, the application software of the invention includes a default distance that is defined between adjacent poles.

In another aspect, referring back to FIG. 2, the invention includes application software with limited functionality 1150. Such software is useful, for example, for supporting field maintenance of an existing network. This limited software runs on a laptop computer 1100, such as might be carried by maintenance personnel in the field. The software and laptop are adapted to communicate via a network 1110, such as the Internet, with a second server 1120 at a different location. In one embodiment, the second server 1120 communicates with a first server 1130 to maintain a mirrored set of files of data and graphics. The first server 1130 in turn communicates with a workstation 1140 running full-function application software.

The limited software 1150 includes functionality such as read, search, query, red-line changes, and splicing updates.

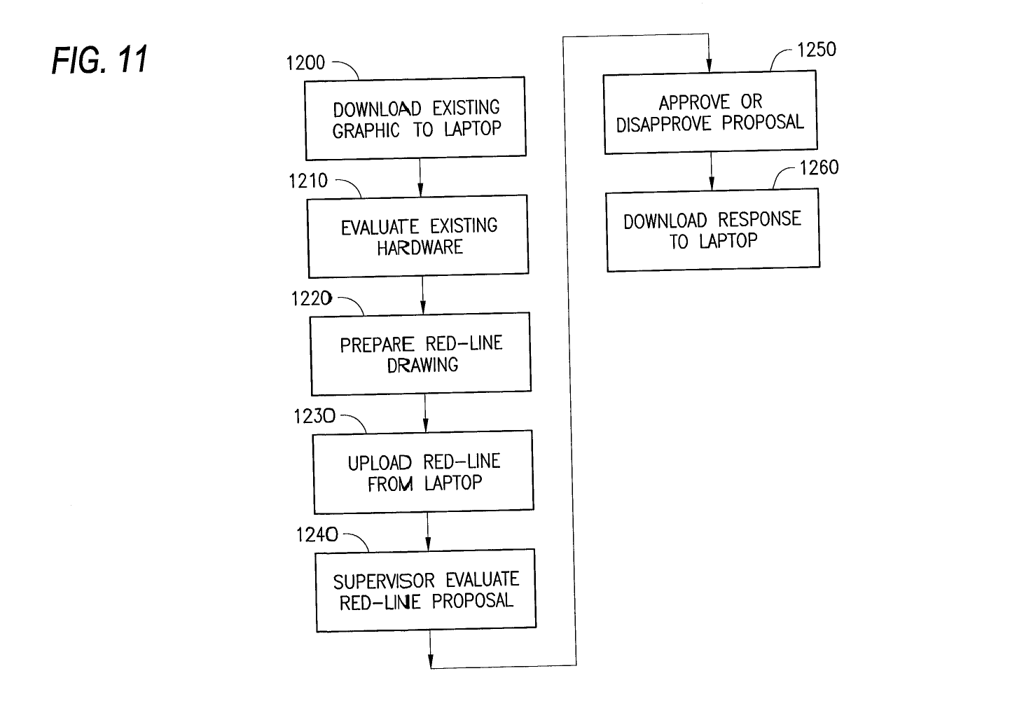

Accordingly, as shown in FIG. 11, the illustrated method includes the steps of downloading 1200 an existing graphic from a workstation 1140 to a laptop computer 1100; evaluating an existing hardware 1210 installation by a field technician; preparing a red-line drawing 1220 by the field technician based on the existing system graphic using the laptop computer; uploading the red-line drawing 1230 from the laptop 1100 to workstation 1140 by way of the intervening network 1110 and servers 1120,1130; evaluating the red-line drawing 1240 by a supervisor based on graphical display of the red-line drawing on the workstation 1140; approving or rejecting 1250 network changes proposed in the red-line drawing; and downloading 1260 to the laptop 1100 a response indicating the rejection or approval. This method allows a supervisor at a central location to control changes being made in the field, and insure that multiple changes made by different technicians at different locations do not interact with each other in an unacceptable fashion.

This aspect of the invention is made particularly useful by providing the ability to post changes with very fast turnaround. In a preferred embodiment, the system includes fully secure communications, including passwords and keylocks. Changes that are disallowed are communicated with an explanation of the reason for disallowance, and changes that are accepted can be easily and immediately entered into the general system database based upon the red-line drawings made in the field.

Referring back to FIG. 3, one sees yet another aspect of the invention including a remote access capability. Under the remote access regime, the application software runs exclusively on a central database server 1300 computer. This software is operated by passing communications to and from the server by means of a network 1310 such as the Internet. A user interacts with the server by means of a user interface terminal 1320.

This is an arrangement advantageous for several reasons, including the ability to maintain key operating software securely on the central server, the ability to provide remote access using relatively inexpensive terminals, and the ability to provide a secure centralized location for network characterizing data. Such centralized storage helps to insure source integrity, since, according to one aspect of the invention, there is only one copy of the database, and one set of graphic files.

In a preferred embodiment, the remote access aspect of the invention includes an automatic reconnection function on interruption. Should communications between a terminal and a central server be interrupted for any reason, the terminal and server automatically reconnect when access is restored.

A further aspect of the invention includes a method for selling network design, deployment, and maintenance services and resources under a fee-based business model. In various embodiments this fee-based model includes payment for use of the remote access system on an hourly basis, or according to a flat fee structure, among other alternatives.

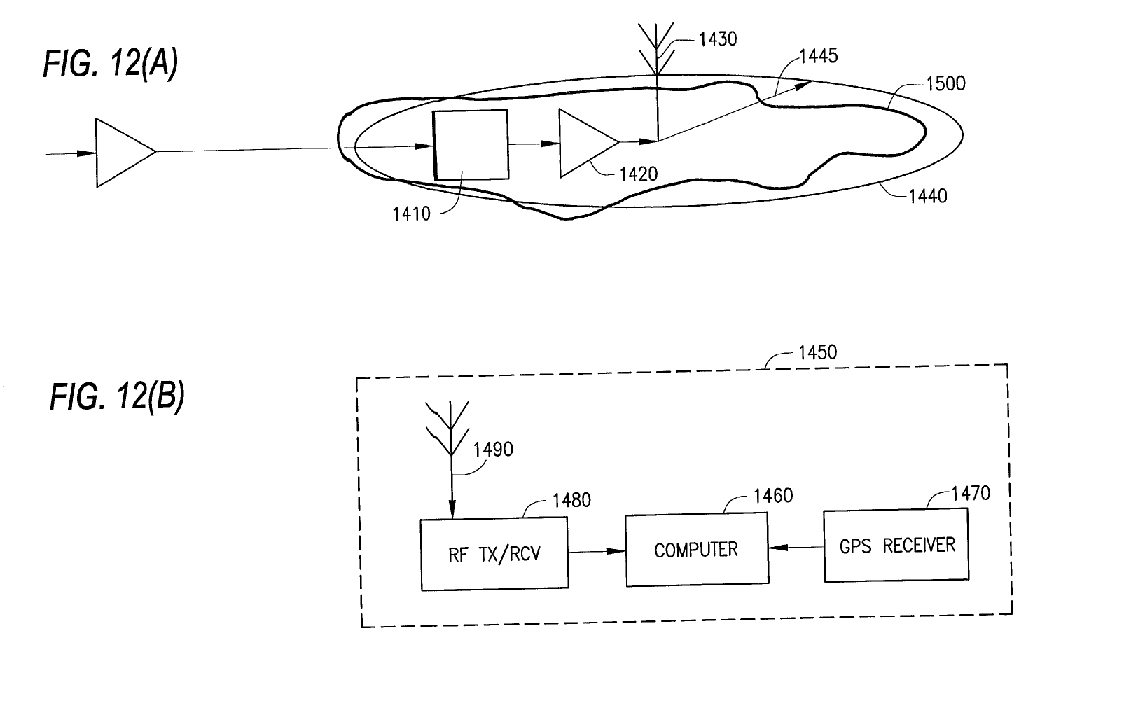

FIG. 12A shows that the invention, in a further aspect, includes facilities for engineering, deploying, and maintaining a communications network including wireless communications portions. Accordingly, the illustrated application software is able to locate and support radiofrequency transmitters 1410, amplifiers 1420 and antenna towers 1430, such as microwave antenna towers. In addition to characterizing the foregoing elements, an embodiment of the invention provides a graphical representation 1440 of a theoretical transmission radius 1445.

In a further aspect, shown in FIG. 12B, the invention includes a mobile apparatus 1450 for sensing information characterizing the signal strength of a signal transmitted from an antenna tower 1430 as a function of geographic position.

As shown, the mobile apparatus 1450 includes a computer 1460 operatively connected to both a global positioning satellite (GPS) system receiver 1470 and a transmitter/receiver 1480, including an antenna 1490, adapted to receive a transmission from an antenna tower 1430.

In one embodiment, the mobile apparatus 1450 directly records signal strength and location for later uploading to a server computer. In another embodiment, measurements of signal strength and position are continuously transmitted to a server over a communications link. In such an embodiment, computer 1460 is optional and may be replaced by communications apparatus.

In operation, the mobile apparatus 1450 is moved with respect to the transmitting antenna 1430 while a series of measurements are taken. By repeated measurements it becomes possible to identify lines of constant signal strength 1500, and display those lines graphically to user. In one aspect of the invention such display is fully automatic. This information is helpful in the selection of appropriate locations for antenna towers 1430.

As a network is designed, using the system of the present invention, various resulting information is available to a user in the form of reports. According to the invention, this information is used in ongoing engineering of the network, and/or in its deployment and maintenance.

The method of the invention is particularly advantageously employed in the development and deployment of optical fiber networks.

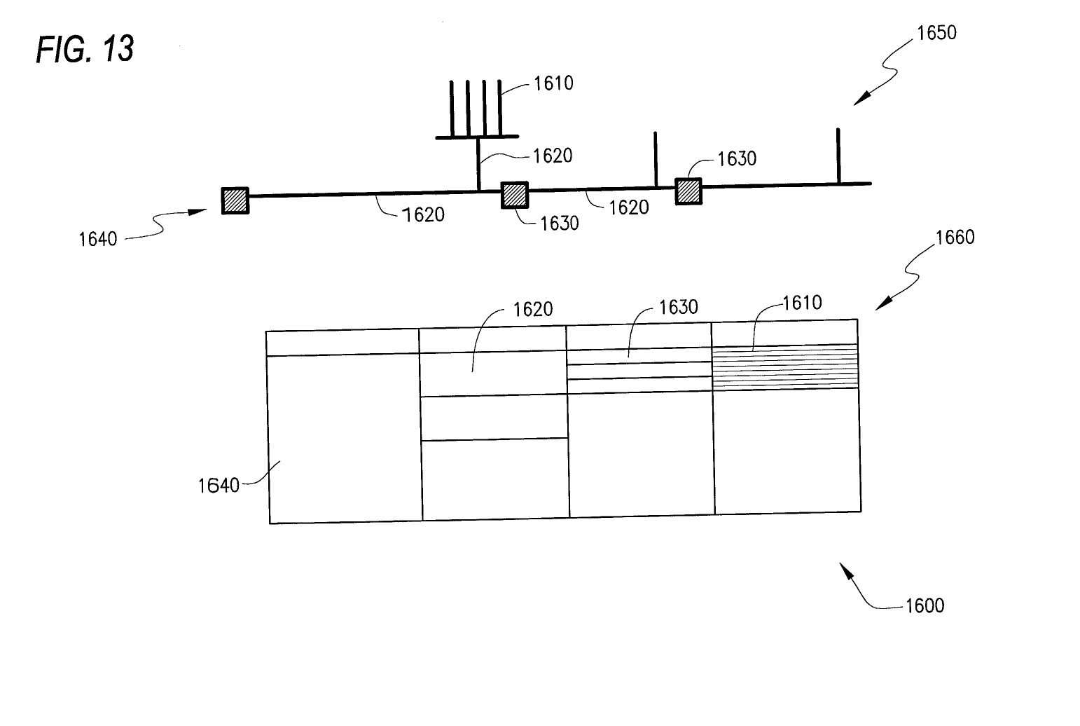

FIG. 13 illustrates an aspect of the invention in which fiber link reports are made available to user. According to one aspect of the invention, fiber reports and traces are generated in real time, thereby ensuring that the most recent information is reported. A fiber link report 1600 shows the identifiers of all fibers 1610, cables 1620, and splices 1630, present in a selected link 1640 . As shown, fiber link information is made available in graphical 1650 and/or tabular 1660 form.

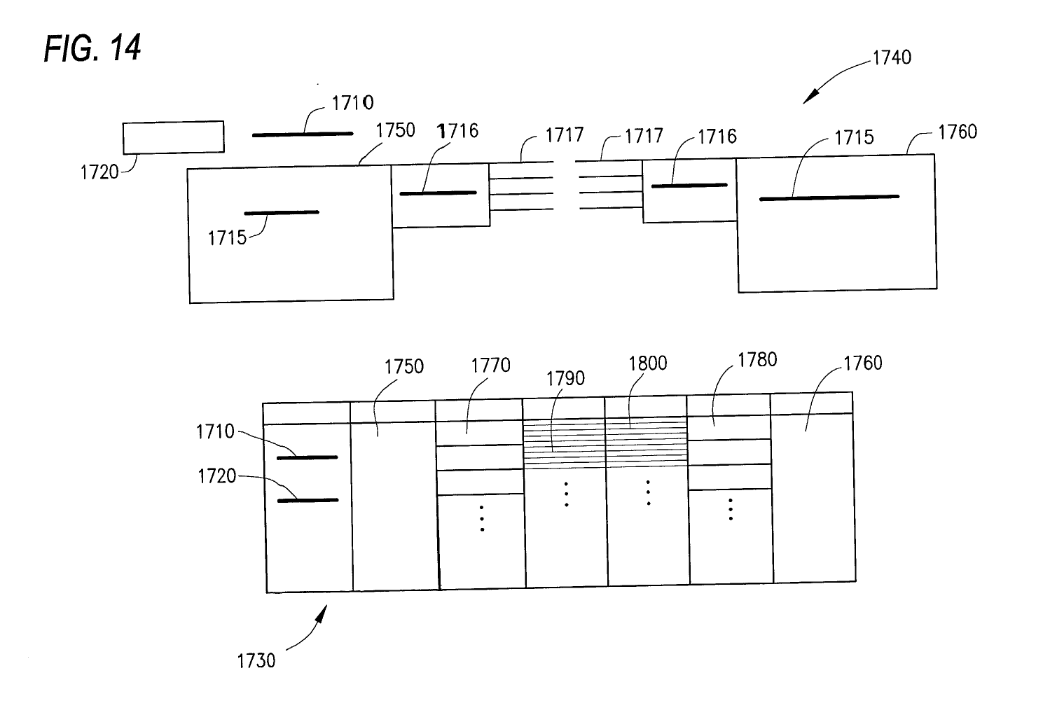

FIG. 14, in similar fashion, illustrates an exemplary splice report 1700, including a circuit identification code 1710, the identity of fibers spliced together, and the geographic address 1720 at which a splice enclosure containing the splice is to be found. Splice report information is available in tabular form 1730. A color-coded graphical representation 1740 of a fiber splice may also be printed, to provide a user with a schematic representation of fiber splices. Included on a typical splice report are the identification of at least first 1750 and second 1760 cables, first 1770 and second 1780 buffers, and first 1790 and second 1800 fibers. The ability to automatically provide color-coded, or otherwise coded, graphical representations of fiber splices is particularly valuable in ongoing efforts to maintain a network.

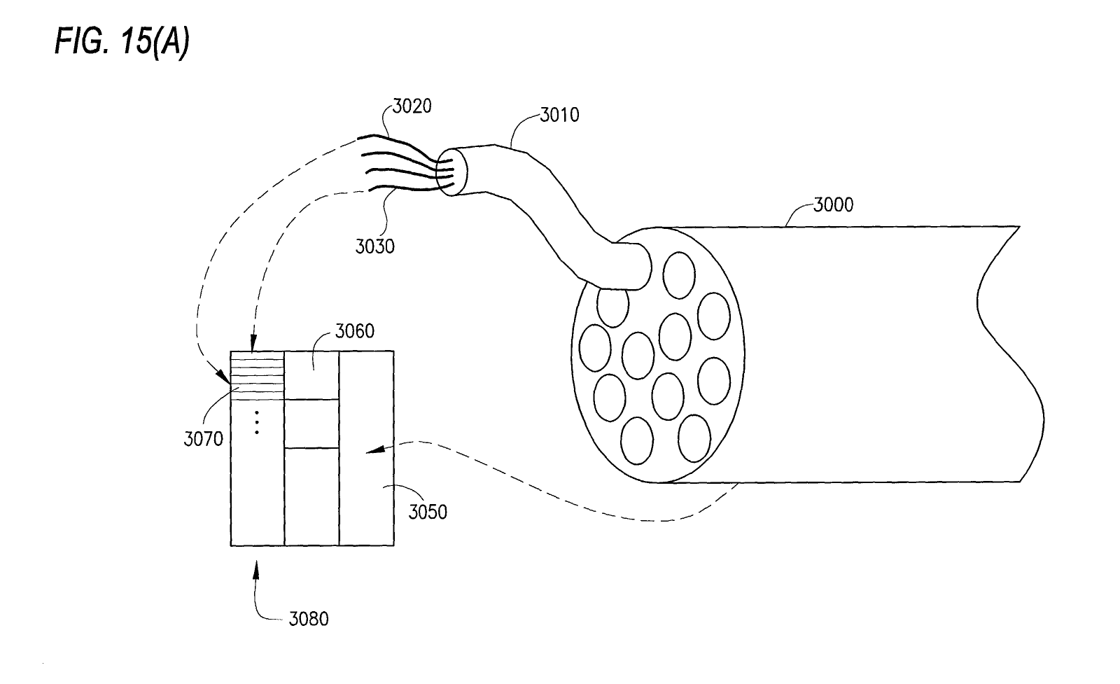

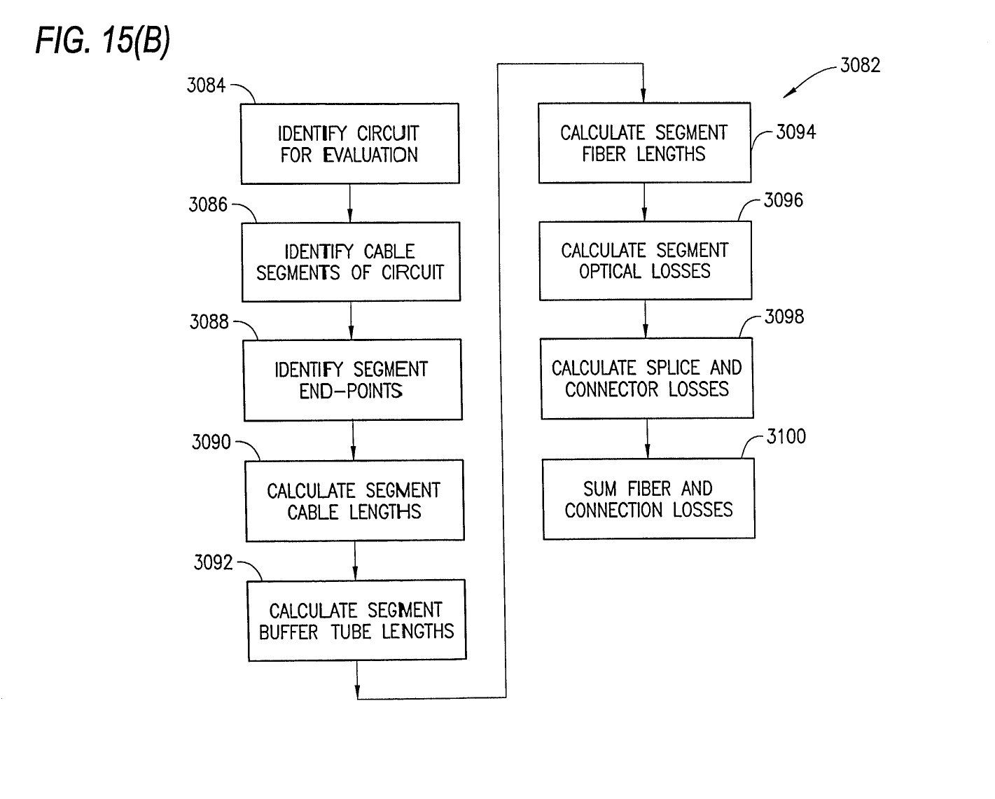

Referring to FIG. 15A, in a further aspect, the present invention is adapted to record, store, and present information related to an optical fiber cable incorporating a plurality of fiber grades within a single buffer tube. Historically, cables of optical fiber each incorporated a plurality of buffer tubes, and the fibers within each buffer tube were all nominally identical. A state-of-the-art cable 3000 incorporates a fiber buffer tube 3010 having more than one grade of fiber. Such cables are advantageous where, for example, different fibers within a buffer tube are used to span substantially different distances. For example, a first fiber 3020 made of superior, but more expensive, glass may be used in long-haul circuits. A second fiber 3030 made of inferior, but less expensive, glass may be used in local circuits. The present invention tracks fiber grade by individual fiber. Cable information 3050, buffer tube information 3060 and fiber information 3070 are related within the database of the invention 3080. Consequently, during engineering and/or maintenance of the system an appropriate choice of fiber may be made. Also, identification and tracking of individual fiber grade allows the calculation functions mentioned above of the invention to accurately model the network. Accordingly, an embodiment of the invention includes optical fiber loss calculation.

Referring to FIG. 15B, calculating optical loss 3082, according to one aspect of the invention, includes identifying a particular circuit for evaluation 3084. Each circuit includes one or more optical cable segments. After selection of the circuit for evaluation, identifying the cable segments or segments of which it is comprised are 3086. Identifying the end points of each segment with particular geographic locations 3088. Calculating the length of each segment based on the known end point locations 3090. Finding buffer tube length from cable segment length 3092. Multiplying a proportionality factor by buffer tube length to calculate fiber length in each segment 3094. By applying a proportionality factor based on fiber type to each fiber length, fiber loss within each optical cable segment is calculated 3096. In one aspect, the invention includes calculating losses for fusion splices and connectors in the circuit, based on standard, or measured, values stored in the project storage portion of the database 3098. Standard default values recalled from the relevant catalog are overridden by entering measured actual values in one aspect of the invention. The invention includes summing of losses for all cable segments, connectors, and splices to yields fiber loss over the circuit 3100. In a further aspect, the system of the invention allows the foregoing calculation despite the presence of different types of glass fiber within a circuit or within a cable segment.

Making use of known fiber losses, calculated as described above, in a further aspect, the invention calculates the splitters necessary to distribute the light from a laser of a given power to a plurality of circuits. This calculation is made automatically based on the entry of geographic circuit locations.

In a further aspect, the invention prevents definition of a new splice into an optical circuit defined as active under normal operation, but provides an override function that allows splicing into an active circuit.

According to another aspect of the invention, and Express Splice Function automatically relates the fibers of a first cable to the fibers of a second cable in a splice relationship. The user acts by defining that the first cable is to be spliced to the second cable. According to the invention logical splicing of the individual fibers is conducted automatically. No action on the part of the user/designer is required.

According to a further aspect, the invention automatically recalculates circuit losses for all affected circuits once such splicing is complete.

In one embodiment, the invention records, in project storage data, the type of connector used at each end of each reel of fiber or fiber segment, and at each input and output of each piece of equipment used in a network as it is defined.

In a further aspect, the invention includes a wild-card fast client lookup that allows rapid identification of a client associated with a length of fiber or a circuit.

In a still further aspect of the invention, graphical displays are provided indicating optical bandwidth and payload management for both analog and digital optical circuits.

A further aspect of the invention includes recording the location and characteristics of unused fiber segments, and providing a function to retrieve that information based on geographic, circuit-based, and client-based queries.

In a further aspect, the invention includes automatically analyzing circuit records to identify the physical optical cable segments that a circuit includes, and providing a graphical representation of the location of each cable segment in the circuit. The result is a graphical representation of the physical circuit path.

Yet another aspect of the invention includes the display of an indicator of the ownership of a particular fiber segment selected manually, or by an automatic process, as discussed immediately above. An indicator of ownership includes, for example, a name or a code number identifying the owner of a particular fiber segment. According to one embodiment of the invention, ownership is tracked to a particular fiber within a buffer tube.

Still further aspects of the invention include fiber optic network-level tracking, that allows the user to assign a particular fiber or fiber optic cable to a primary ring, a secondary ring, and/or a lateral connection in a communication network.

Another aspect of the invention includes tracking individual circuits by fiber. Such tracking is particularly valuable in the context of optical transmission media, since the bandwidth of an individual fiber is much larger than that of an individual cable. The result is that a large number of circuits are associated with a single fiber, and specific tracking of circuit is therefore valuable.

Also included in an embodiment of the invention is graphically tracking whether a particular section of optical cable is proposed, under construction, operational, out of service, or abandoned. Also within the scope of the invention is a function that displays payload assignment by client and optical wavelength in a particular fiber segment.

An aspect of the invention includes representation of optical cable construction as aerial, underground, or both.

In another aspect, the invention provides a user selectable option to allow placement of optical fiber cables with, or without, associated support structures.

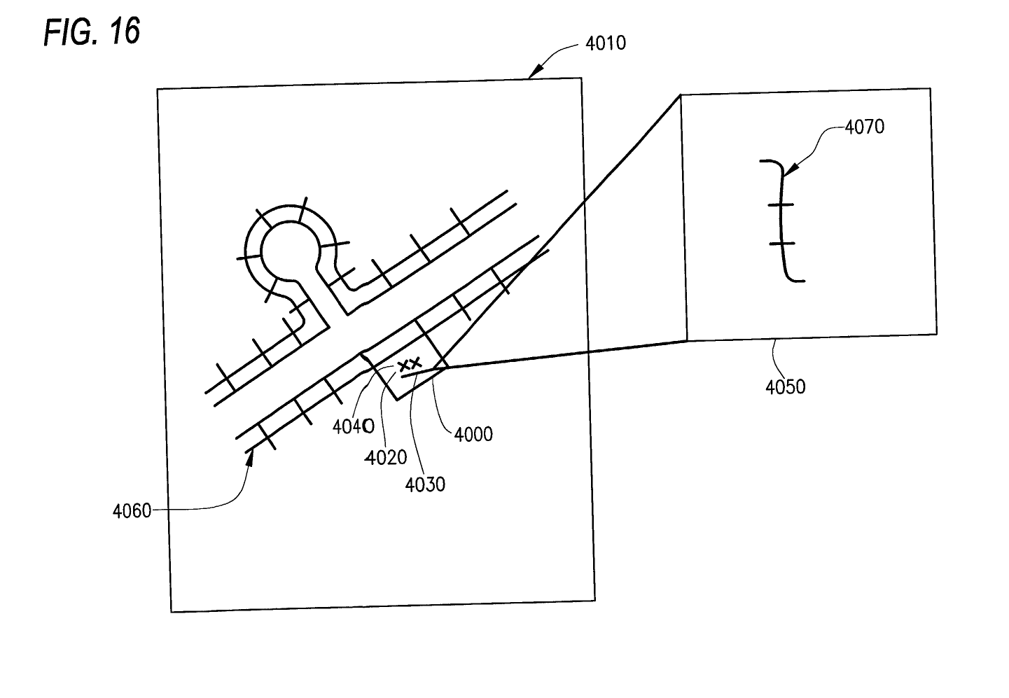

FIG. 16 illustrates a further aspect of the invention related to the insertion of map detail notes. In particular, the present invention allows a user to associate a separate “paper space” with a particular geographic location. A paper space is a data area in which a discrete set of information can be recorded. According to the invention, a user identifies a location 4000 on a map 4010 presented by the application software of the invention. A graphical indication 4020 (for example underline 4030 of a geographic address 4040) is inserted, and thereafter displayed on the map at that location. Selecting the location by a mouse click on the graphical indication 4020, for example, initiates the display of a particular information set 4050. In one embodiment of the invention, network components represented within the information set of map detail notes are treated as contiguous with the information otherwise represented on the map. Accordingly, details of a network are represented at different scales.

Large-scale 4060 aspects of the network are represented on a map, while finer scale aspects 4070 of the same network are represented within a detail note. Where connections have been defined by a user between large and small scale features of the network, system calculations such as power supply or signal level calculations automatically consider both the large-scale and small-scale features, according to one aspect of the invention.

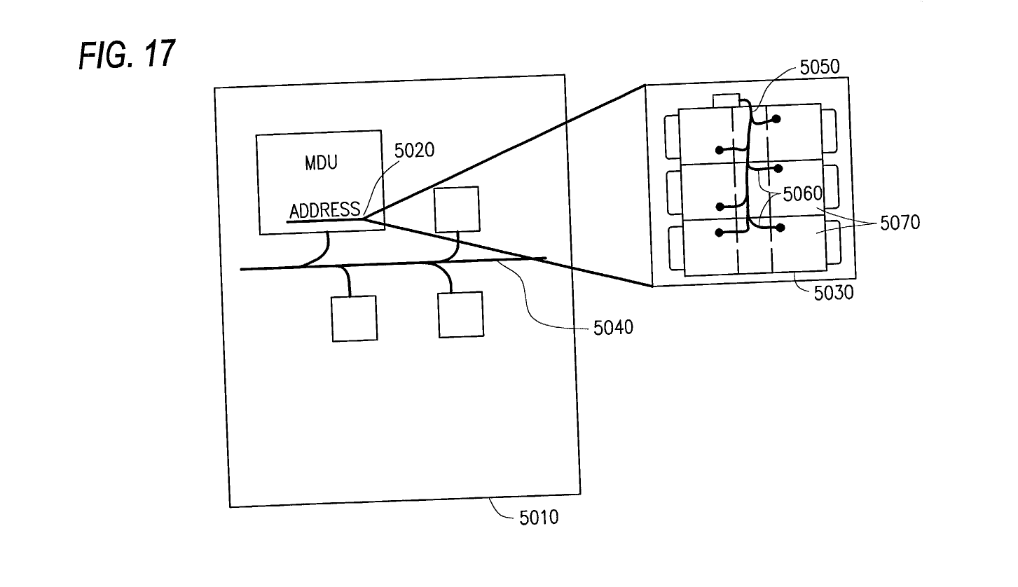

Referring now to FIG. 17, in a particular refinement of the invention, the map notes described above are specialized for the representation and management of detailed information related to multiple dwelling units (MDU's). As illustrated in FIG. 17, the method of the invention includes attaching a specialized map detail note 5000 to a map 5010 at a location 5020. An architectural drawing 5030, such as a floor plan or riser diagram, is included within the specialized note 5000. The user logically connects a first portion of a link 5040 represented on the map to a further portion of the same link 5050 represented on the detail note 5000. The further portion of link 5050 represented on the note may include connections 5060 to any number of locations 5070 within the multiple dwelling unit. Each of these locations 5070 may be treated as discrete terminals associated with the link. Accordingly, logical connectivity is maintained between a larger network and the small scale detail of the network represented on the map note.

In a similar refinement, a detailed representation of the media, equipment, and splices within a manhole, or other junction enclosure, are represented with a specialized detail note, according to the invention. According to this infrastructure support function, in one aspect, a graphical report is created representing conduits available in the sides of a manhole, and indicating the presence of particular fibers, cables, and circuits using text tags and color coding of graphical indicators.

While there have been shown and described the fundamental and novel features of the invention as applied to preferred embodiments, it will be understood that various substitutions and changes in the form and details of the devices illustrated, and in their operation, may be made by those of skill in the art without departing from the spirit of the invention. It is our intention, therefore, to be limited only as indicated by the following claims.

What is claimed as new and desired to be protected by Letters Patent of the United States is:

1. A method for deploying a fiber optic communication network comprising:
storing an attribute of an optical communication component in a catalog database entry;
associating said catalog database entry with a design profile;
selecting said database entry from said design profile;
reading said attribute from said database entry; and
associating said attribute with a planned deployment of a physical instance of said component.

2. A method as defined in claim 1, further comprising iterating said associating step a plurality of times, and further associating said attribute of a component of a first iteration with said attribute of a component of a second iteration.

3. A method as defined in claim 1, further comprising recording said association in a computer memory.

4. A method as defined in the claim 1, further comprising physically deploying said physical instance of said component.

5. A method as defined in claim 1 further comprising identifying a geographic location for said planned deployment.

6. A method as defined in claim 5 further comprising providing a graphical representation of said geographic location and said physical instance.

7. A method as defined in claim 5 wherein said optical communication component comprises a component selected from the group of an optical cable, an optical cable connector, a splitter, an optical amplifier, an optical repeater, an optical transmitter, an optical splice enclosure, a patch panel, and a splice tray.

8. A method as defined in claim 1 wherein said optical communication component comprises an optical cable, said optical cable comprising a cable selected from the group of ribbon cable, loose tube buffer cable central tube cable, odd count fiber cable, single mode fiber cable, multimode fiber cable, and cable including a plurality of fiber types.

9. A method as defined in claim 8 wherein said optical cable includes a plurality of optical fibers said plurality comprising a number of fibers between about one fiber and about 2600 fibers.

10. A method as defined in claim 1 wherein said planned deployment includes identification of said instance with an owner.

11. A method as defined in claim 1 wherein said planned deployment includes identification of said instance with a communication circuit.

12. A method as defined in claim 1 wherein said planned deployment includes deploying a plurality of optical communication components

13. A system for planning a network comprising:
a first computer including a first memory storage device having application software encoded therein;
a second computer, operatively connected to said first computer, having a second memory storage device adapted to record first project data;
a third computer, operatively connected to said second computer, having a third memory storage device adapted to record second project data, said first and second project data being substantially instantaneously identical;
said software including a catalog portion, a design profile portion, and a calculations portion;
said catalog portion being adapted to receive data defining a plurality of communication network components;
said design profile portion adapted to receive data defining a plurality of design rules related to logical design of a network; and
said first data including a logical model of a communications network;
said calculations portion being adapted to calculate power and signal relationships within said communications network.

14. A system as defined in claim 13, wherein said communications network comprises an optical fiber portion.

15. A system as defined in claim 14, wherein said optical fiber portion comprises an optical cable having a buffer with first and second optical fibers;
said optical fibers having different nominal characteristics.

16. A system as defined in claim 13, wherein said communications network comprises a wireless communication portion.

17. A system as defined in claim 13, wherein said software further comprises a detail notes portion adapted to record detailed layout of a network within a multiple dwelling unit.

18. A system for planning a network comprising:
a computer including a memory storage device having application software encoded therein;
said software including a catalog portion, a design profile portion, a project storage portion, and a calculations portion;
said catalog portion adapted to receive data defining a plurality of communication network components;
said design profile portion adapted to receive data defining a plurality of design rules related to logical design of a network;
said project storage portion adapted to receive data including a logical model of a communications network;
said calculations portion adapted to calculate power and signal relationships within said communications network;
said communications network including an optical fiber portion.

19. A system for planning a network comprising:
a computer including a memory storage device having application software encoded therein;
said software including a catalog portion, a design profile portion, a project storage portion, and a calculations portion;
said catalog portion adapted to receive data defining a plurality of communication network components;
said design profile portion adapted to receive data defining a plurality of design rules related to logical design of a network;
said project storage portion adapted to receive data including a logical model of a communications network;
said calculations portion adapted to calculate power and signal relationships within said communications network;
said communications network including an optical fiber portion; and
one of said communication network components including an optical cable having a buffer with first and second optical fibers, said optical fibers having different nominal characteristics.

20. A system for planning a network comprising:
a computer including a memory storage device having application software encoded therein;
said software including a catalog portion, a design profile portion, a project storage portion, and a calculations portion;
said catalog portion adapted to receive data defining a plurality of communication network components;
said design profile portion adapted to receive data defining a plurality of design rules related to logical design of a network;
said project storage portion adapted to receive data including a logical model of a communications network;
said calculations portion adapted to calculate power and signal relationships within said communications network;
said communications network including a wireless communication portion; and
one of said communication network components including an antenna adapted to radiate radio frequency signals.

21. A method of deploying a communications network comprising:
providing first and second computers including first and second memory storage devices respectively, each having application software encoded therewithin;
operatively connecting said first and second computers through a communications link;
including a logical model of a communications network within said first storage device, said model including first and second logical communication cables, said model depicting operative connection of said first and second cables;
receiving said logical model through said link into said second computer memory device;
representing said logical model graphically; and
operatively connecting first and a second physical communication cables according to said model.

22. A method as defined in claim 21 further comprising the step of transmitting a notice of completion of said operative connection of physical cables through said link into said first computer.

23. A method as defined in claim 21 further comprising the step of modifying said graphically represented logical model;
transmitting said modified logical model to said first computer and subsequently receiving authorization for said operatively connecting first and second physical communication cables.

24. A method as defined in claim 21, wherein said method further comprises:
characterizing the signal strength of a radio frequency signal as a function of geographic location; and
using said characterization to locate a radio frequency antenna.

25. A method of deploying a communications network comprising:
providing first and second computers including first and second memory storage devices respectively, each having application software encoded therewithin, said second computer being a portable computer;
operatively connecting said first and second computers through a communications link;
including a logical model of a communications network within said first storage device, said model including first and second logical communication cables, said model depicting operative connection of said first and second cables;
receiving said logical model through said link into said second computer memory device;
representing said logical model graphically; and
operatively connecting first and second physical communication cables according to said model.

26. A method as defined in claim 25 wherein said portable computer comprises a laptop computer.

27. A method of modeling a fiber optic communication network comprising:
defining a land base map;
defining a first plurality of optical network components including a second plurality of optical cable segments;
associating each component of said first plurality with a location of said land base;
associating each component of said first plurality with at least one other component of said first plurality;
calculating signal loss through at least one segment of said second plurality; and
displaying said land base map and said signal loss calculation result.
